(19) United States
(12) Patent Application Publication
(10) Pub. No.: US 2002/0184196 A1
(43) Pub. Date: Dec. 5, 2002

(54) System and method for combining voice annotation and recognition search criteria with traditional search criteria into metadata

(76) Inventors: Michelle R. Lehmeier, Loveland, CO (US); Robert E. Sobol, Fort Collins, CO (US); Edward S. Beeman, Windsor, CO (US)

Correspondence Address: HEWLETT-PACKARD COMPANY, Intellectual Property Administration, P.O. Box 272400, Fort Collins, CO, 80527-2400, US

(21) Appl. No.: 09/873,687

(22) Filed: Jun. 4, 2001

(51) Int. Cl. G06F 7/00

(52) U.S. Cl. 707/3

(57) ABSTRACT

The present invention is directed to a system and method which uses metadata to create an association between key words in textual files or files containing text; key objects in image files or pictures; and key names associated with textual files, files containing text, image files and picture files and the files or their file names. Key words in textual files or files containing text can be identified by the user or through semantics processing. Key objects in image and picture files can be identified by the user or through object recognition software. Key names in textual files, files containing text, image files and picture files are identified by a narrative or other spoken words given by the user to the processing system with respect to specific pictures.

### BACKGROUND

The generation and use of keywords to index, store and retrieve textual documents is well known in the prior art. These keywords are typically generated by the document's creator and are used as an indication of document content and aids in the selection and retrieval of applicable documents from a document or image database. Additionally, it is well known in the prior art that the body of textual documents can be searched for specific words or phrases to find a textual document, or an area of the document which is of interest to the searcher. Similarly, computer directories or subdirectories may be searched to identify documents which pertain to certain subjects, areas of interest, or topics. Keywords can also be associated with these subdirectories, using a subdirectory naming convention, to indicate the data which is contained within a subdirectory. While various search engines provide for searching of written documents, searching of other forms of materials, such as images, is not well supported. Further, most documents and other databases do not readily support searching other than in the context of the object stored and, more commonly, by file name or other text based searching routines.

### SUMMARY OF THE INVENTION

The present invention is directed to a system and method which provides for enhanced indexing, categorization, and retrieval of documents by, according to one aspect of the invention, combining index terms derived from document content and file information with user provided information, such as spoken commentary. The spoken commentary may be stored as a digitized audio file and/or subjected to processing, such as speech recognition, converting the spoken commentary to, for example, text. The text may then be parsed (searched and portions extracted for use) to identify and extract additional searchable terms and phrases and/or be used to otherwise enhance and support document access, search, identification, and retrieval capabilities.

In one embodiment of the present invention, a document retrieval system comprises a document processing engine which is configured to extract search keys or internal characteristics from a plurality of files. A speech recognition engine is also included which is configured to convert spoken characteristics associated with each of the files, to spoken characteristic data. Further included is a data structure which associates the search keys or internal characteristics and the spoken characteristics with the file name in metadata. A search engine is also included which is configured to search the internal characteristics of the metadata for the spoken characteristics to identify the associated files.

Another embodiment of the invention is a method of identifying documents which is comprised of identifying internal characteristics of a file, converting spoken words associated with the file into spoken characteristics which are also associated with the file, and creating metadata which associates the internal and the spoken characteristics with the file.

Another embodiment of the invention includes an image storage system which is comprised of an image capture platform which provides captured images, and a memory storing image data captured by the image capture platform together with the spoken information relating to the image data. The memory also stores metadata which provides an association between the captured images and the spoken information.

Another embodiment of the present invention includes a system for storing documents in an electronic storage media including a means for obtaining data tags pertaining to certain characteristics of each document which are selected from a list of recognized characters, semantics processing, object and voice recognition and a means for associating the data with the document.

### BRIEF DESCRIPTION OF THE DRAWING

FIG. 1 is a block diagram of a method of differentiating textual documents;

FIG. 2 is a block diagram of a method of differentiating image or picture documents;

FIG. 3 is a block diagram showing the use of voice annotation and recognition in conjunction with additional search criteria;

FIG. 4 is an example of a database which associates documents with their keywords, keynotes and key objects; and

FIG. 5 is a block diagram of a system which implements the current invention.

### DETAILED DESCRIPTION

The present invention is directed to a system such as a document retrieval system, and a methodology for identifying documents which can be applied to both textual documents as well as photographic documents or images. The invention is equally applicable to an image storing system for storing document in electronic media. Typically, document users identify desired documents by the file name or through keyword searches of computer text files. When many similar documents are stored, differentiating the various documents by file name in a meaningful way becomes difficult, if not impossible. The next step in differentiating documents is to supply document keywords or other groupings to indicate the information the documents contain or that are otherwise associated with the document (e.g., synonyms of terminology used in document, related concepts, etc.). These words or groupings can consist of keywords, or sentences which describe the information contained in the textual document. Similarly, images stored on electronic media can be differentiated from one another by the image's file name. These images can be further differentiated by their placement within the electronic media. For instance, distinct media or separate subdirectories within a media can be created which include only images of a certain subject matter. Thus, for example, if a user stores all their photographs on electronic media, a single diskette can be dedicated to vacation pictures from 1995, a separate diskette can be dedicated to vacation pictures from 1996, and a third diskette can be dedicated to pictures from the vacation in 1997. These storage techniques mimic traditional photo albums. Alternatively, subdirectories can be used on a single recording device (e.g., hard drive) to differentiate photographs from various time periods or vacations. The current invention builds and expands on these capabilities by allowing the user to associate spoken words, phrases or text extracted from an image with annotation on the textual or image document to identify documents, access the document, or differentiate the document among other unrelated documents.

One object of this invention is to combine keyword capability with other user-supplied information to identify and access textual documents. Additionally, a further object of the invention is to enable images stored by a computer to be indexed, sorted, and accessed by reference to objects included within the images and/or by user-supplied information. A still further object of the invention is a method in which an individual may annotate a document and use the annotation to search and retrieve documents and other objects from a database.

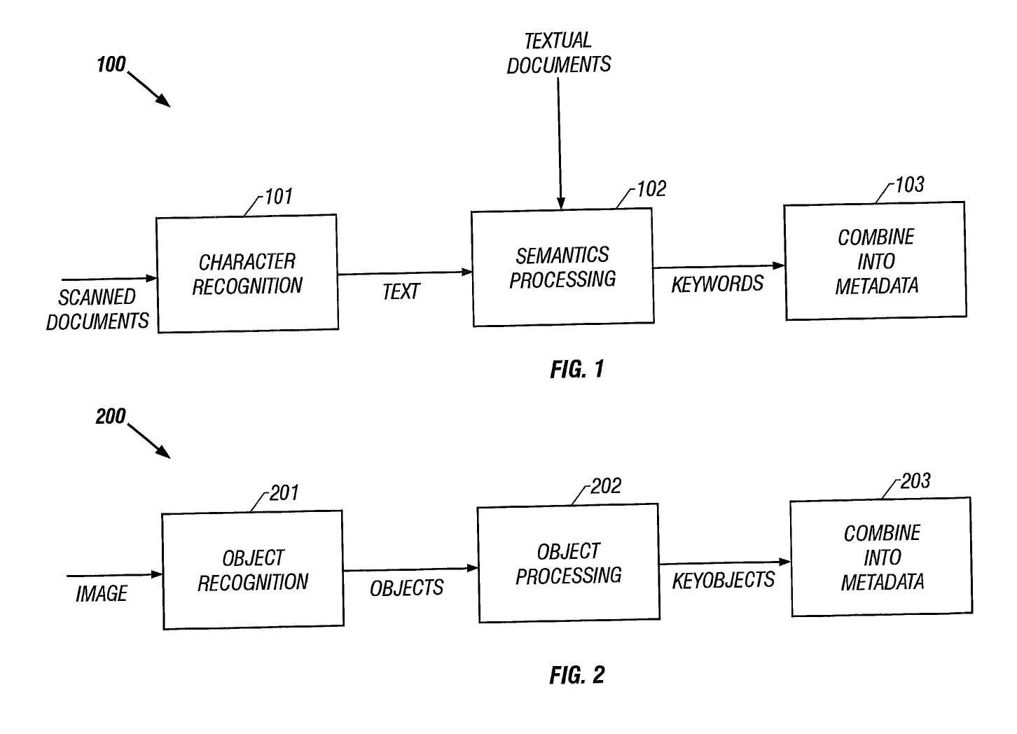

Referring now to FIG. 1, a procedure for differentiating textual documents is illustrated. Textual documents can be the result of word processed documents or scanned documents. Scanned documents, for instance, are created from optical scanning hard copies of documents into a file. These scanned documents are fed to a character recognition program (i.e., an Optical Character Recognition (OCR) program), which translates pixel image information contained within the scanned document to textual information. This function is performed by character recognition block 101 of FIG. 1. For textual documents generated by a word processing program this step may be omitted. The resulting textual information can then be accessed by a word processing program to delete, change, or add to the information contained within the body of the textual document. The textual document can also be accessed by semantics processing block 102 to identify keywords associated within the textual information. Such semantics processing programs may respond to the number of times a specific word appears within the document, the keywords assigned to the textual document by the user, or by any other method which distills the textual information down to a number of keywords which describe and/or characterize the textual document. These keywords can then be processed by metadata program 103 which will assign the keywords as indexes to the associated textual document. This assignment, may for example take the form of a table which associates keywords with file or document names. FIG. 4 depicts one representation of this association. This metadata may take several different forms, including a database which tracks document names or file names with their associated keywords.

Referring now to FIG. 2, keywords can also be associated with images, or digital pictures as shown in process 200. Digital pictures, or scanned images can be processed by object recognition program 201 to identify the specific objects included within the digital photograph or scanned image. Object recognition program 201 may consist of software which detects edges between various objects within a digital photograph or scanned image, and may identify the images contained within the picture or scanned image by comparison(s) to objects included in a database. Once object recognition program 201 has identified the objects contained within a digital photograph or scanned image, object processing block 202 processes the identified objects to determine the key objects contained within a digital photograph or scanned image, these key objects are combined into metadata 203 to provide an association between the key objects and a digital photograph or scanned image.

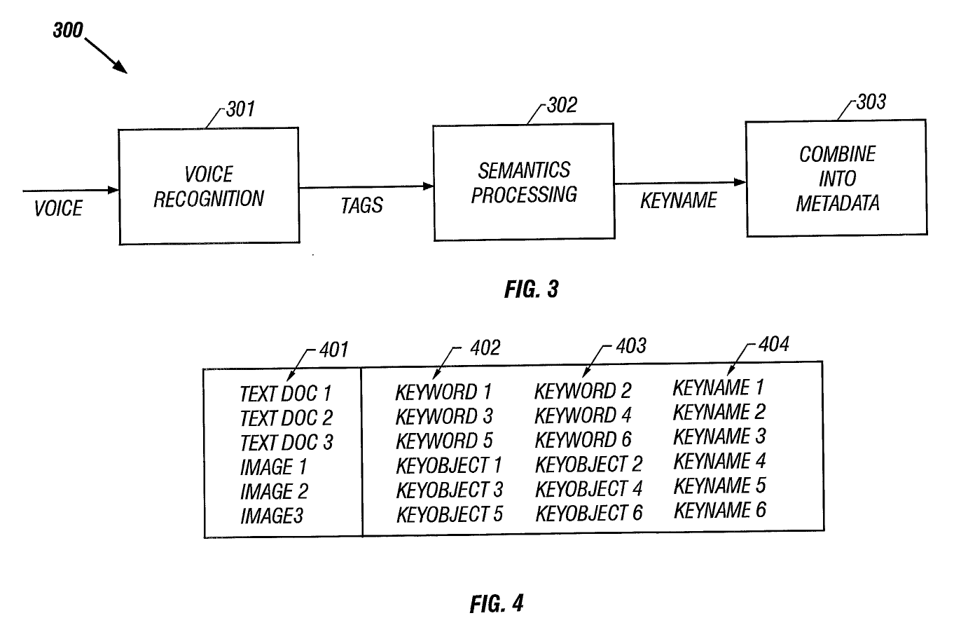

Similarly, as shown in FIG. 3, a processor or a processing system may accept a user's voice which includes a description of either a scanned image, a textual document, or digital photograph, video, graphics file, audio segment, or other type of data files. As shown by process 300, translation program 301 preferably converts the received voice into tag information. This tagged information is then processed by semantics processing code 302 which determines the keywords extracted from the spoken data and associated with the scanned document, textual document, or digital photograph. These keywords are then combined into the metadata in block 303 and provide further information concerning its associated file. Spoken data may be recorded at the time the image was recorded, when it was scanned into the computer or at any other time an association between the image and the spoken words can be established.

FIG. 4 shows an example of the structure of metadata. Metadata may be any association between the document names or file names and the information contained within the document (key words and/or key objects) and the voice information (key names) supplied by the user which is also associated with the document or file. The database illustrated in FIG. 4 shows one example of metadata. In this example, first column 401 consists of the names of the various documents or files contained within the metadata. Columns 402, 403 and 404 preferably contain attributes which describe the files themselves. For example, for text document 1, two keywords (KEYWORD 1 and KEYWORD 2) were determined through the keyword processing (FIG. 1, 100) and are associated with text document 1 in columns 402 and 403 respectively. Similarly, the image processing (FIG. 2, 200) identified two key objects (KEY OBJECT 1 and KEY OBJECT 2) for image 1 and they are associated with image 1 in FIG. 4. Key names identified through process 300 (FIG. 3) are also associated with various text documents and image files and are included in column 404. One of ordinary skill in the art would understand that the metadata is not necessarily contained in the database of FIG. 4, that many representations of the metadata are possible and that FIG. 4 illustrates only one possible representation. One of ordinary skill in the art would also understand that if a database is used in the implementation of the metadata, the database is not limited to any particular number of columns and rows.

One example of the usefulness of the present invention can be demonstrated by describing how the present invention can be applied to the photographs a typical family takes. Suppose for instance, a family has several hundred photographs. Some of these photographs are in digital format, and others are contained in conventional photographs. The conventional photographs can be scanned into a computer, and each resulting file may be named. The resulting scanned images from the conventional pictures can then, using process 200 of FIG. 2, undergo the steps of object recognition and object processing where key objects are identified. These key objects can be combined with the image file name to form metadata. Digital photographs can be similarly processed, key objects identified and associated to the file through metadata.

For example, assume ten of the photographs previously mentioned included photographs of various family members playing soccer. In object recognition step 201 (FIG. 2), these ten photographs of soccer-related events could be identified from objects such as the soccer ball and the soccer goal. Other objects such as grass and trees may also be identified. Object recognition software 201 would identify these various objects within these ten soccer-related pictures. Object recognition software 201 may also identify individuals by their visual characteristics who appeared in the image files. These individuals can be assigned unique identifiers to distinguish them from each other. Once the objects included in the ten soccer-related pictures. Object processing step 202 would determine which objects in the pictures are important and should be kept track of. Object recognition step 201 may have also identified, in addition to the soccer ball and the individuals present in the picture, that the game was played on grass, that the games were played during daylight hours, that there were trees in the background, or a number of other characteristics of the ten soccer-related pictures. In object processing step 202, process 200 identifies the number of objects which should be included within the metadata associated with this image file. The maximum numbers of objects to be included for each image file in the metadata may be defined by the user, may be included as a default in the processing software, may be obtained from a corresponding table or file format, etcetera. Once object processing step 202 has identified the key objects, the key objects are associated with the image file in the metadata in step 203. Process 200 of FIG. 2 may be performed at the time the image was scanned, at a later time as defined by the user, or at any other time as defined by the software and/or the user.

Once the ten soccer-scanned photographs are processed by the system, process 300 of FIG. 3 enables the user to associate additional information with each picture. For instance, referring back to the conventional ten soccer photographs, a first soccer image can be displayed to the user on the screen, and the user can identify the individuals contained within the photographic image, their ages, their relationship to the user, the date and/or time of the soccer game, the circumstances in which the soccer game was played and any other information the user decides to associate with the scanned image. In this example, the user, while viewing the first soccer image may identify two individuals on the soccer field as their son Dominick and their daughter Emily. The user may also indicate that in the photograph Dominick is 6 and Emily is 7, that the soccer game was Dominick's first soccer game and that during this soccer game Emily scored her first goal. This information about the photograph may be provided by text input using a keyboard, designating menu items using a mouse or other positional input device, speech-to-text processing, etc. The information supplied by the user is translated in step 301 of FIG. 3 into tags that are associated with the scanned image. Semantics processing step 302 may be included, but is not necessary. For instance, if the user simply said “Dominick, Emily, Dominick age 6, Emily age 7, Dominick's first soccer game, Emily's first goal”; the user has identified to the system the keywords the user would like the system to associate with the scanned image. If, however, the user supplies the information to the system in the form of a conversation or a narrative, semantic processing step 302 preferably will be used to extract the key attributes from the narrative. Once the key attributes or key names are identified and associated with the scanned image, this information is combined into the metadata in step 303. Digital photographs can similarly be associated with key objects and key names.

Once the system has a name associated with an object, this information can be maintained within an associated database so that the object is correctly identified in the future. For instance, in this example, when process 200 of FIG. 2 was first performed on the first soccer picture, a soccer ball, two individuals, the grass field, daylight and the trees in the background were identified as objects by object recognition step 201. However, at that time, object recognition step 201 was unable to assign unique identifiers to two individuals since object recognition step 201 had no way to associate names with the specific individuals. These identifiers can be used to later associate the individual name with their image. Once the user, using process 300 of FIG. 3, identifies the two individuals in our example, Dominick and Emily, Dominick and his associated image as well as Emily and her associated image are stored in the object recognition database for future identification. An association between images of Dominick and Emily from other stored images can now be made and previously assigned unique identifiers can be replaced with the individual's name.

Once the keywords, key objects and key names are associated with files the metadata can be used to identify specific files. The metadata now includes in, connection with the soccer picture number information, identification of the soccer ball, Dominick, Emily, the grass field, the trees, Dominick's age at the time of the picture, Emily's age at the time of the picture, the fact that the picture is of Dominick's first game and Emily's first soccer goal, and any other information entered by the user or extracted by the software. The user can now perform searches of the metadata to identify specific pictures from a number of other pictures. For instance if the user queries the system to identify all pictures which are soccer-related, the ten soccer pictures identified previously would be indicated. Additionally, the user can also query the metadata as to when Emily first scored a soccer goal, and the metadata would be able to identify the picture which corresponds to that event.

Image files which began as digital photographs may be similarly processed by process 200 of FIG. 200 and key names associated with the photograph through process 300 of FIG. 3. Similarly, textual files can have key names associated with the textual files as depicted by process 300 of FIG. 3.

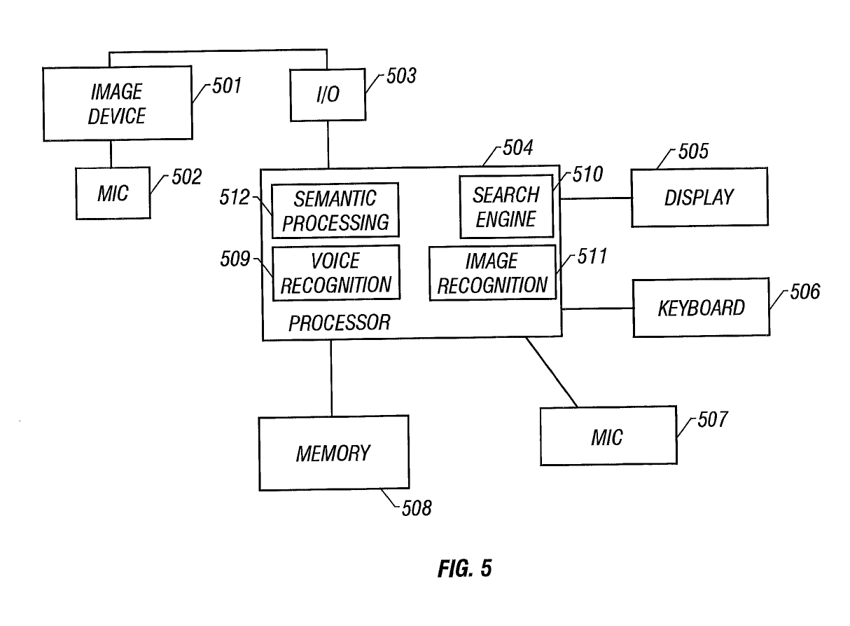

FIG. 5 is a diagram of an image storage and retrieval system which implements the current invention. In FIG. 5, imaging device 501, which may include microphone 502, is attached to input/output (I/O) device 503 of processor 504. Processor 504 may be, for example, a document processing engine. Processor 504 is connected to display 505, keyboard 506, preferably microphone 507 and memory 508. Within processor 504, or attached to processor 504, are voice recognition or speech recognition 509 capability, search engine 510 and image recognition capability 511. Imaging device 501 may be a digital camera, a scanner or any other device which allows photographic or image data to be entered into, and processed by processor 504. Microphone 502, if present, may allow a user to record and associate spoken data with a specific image. The imaging data, and any associated spoken data enters processor 504 through I/O device 503. I/O device 503 may also include a disk drive, tape drive, CD, DVD or any other storage device which can be used to introduce image, textual or digital documents or files into processor 504.

Display 505 allows the user to visualize the images, photographs or textual documents as they are associated with keywords, key names or key objects. These associations may be made via user input through keyboard 506, microphone 507 or from image or textual semantics processing 512 capabilities of processor 504. Image recognition 511 capabilities are included in processor 504 for the identification of specific images within image files or photographs. A voice recognition capability translates spoken data received via microphone 502, microphone 508 or I/O device 503 into textual format for inclusion into metadata. Search engine 510 allows the user to process specific metadata information and allows the identification of specific files of interest.

As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. Additionally, while a database implementation of the metadata has been described, any searchable association between the file names and the key words, key names and key objects can also be used to implement the metadata.

What is claimed is:

1. A document retrieval system comprising:
a document processing engine configured to extract search keys from a data file to identify internal characteristics of said data file;
a speech recognition engine configured to convert spoken characteristics associated with certain said files to spoken characteristic data; and
a data structure which associates said internal characteristics of a file and any said spoken characteristics of a file with said file in a memory.

2. The document retrieval system of claim 1 further comprising:
a search engine configured to search for said internal characteristics and any said spoken characteristics within said memory so as to identify files associated with said internal characteristics and any said spoken characteristics.

3. The document retrieval system of claim 1 wherein at least some of said files contain textual information.

4. The document retrieval system of claim 2 further comprising a character recognition engine configured to provide said textual information.

5. The document retrieval system of claim 1 wherein at least some of said files contain image data.

6. The document retrieval system of claim 4 wherein the document processing engine includes an object recognition system.

7. A method of identifying documents comprising the steps of:
identifying internal characteristics of a file;
converting spoken words associated with said file into spoken characteristics associated with said file; and
creating metadata associating said internal characteristics and said spoken characteristics with said file.

8. The method of claim 6 further including the step of:
searching said metadata to identify said file.

9. The method of claim 6 wherein said internal characteristics of a file include textual information.

10. The method of claim 8 further comprising the step of recognizing print characters to provide said textual information.

11. The method of claim 6 wherein said file contains an image.

12. The method of claim 10 further comprising the step of recognizing and classifying at least one object depicted in said image.

13. An image storage system comprising:
an image capture platform providing captured images;
a memory storing image data captured by said image capture platform together with said spoken information relating to said image data; and
a metadata providing an association between said captured images and said spoken information.

14. The image storage system of claim 13 further comprising:
a microphone providing spoken information.

15. The image storage system of claim 12 further comprising:
an object recognizer providing identification of objects within said captured images.

16. The images storage system of claim 12 further comprising a speech recognition engine configured to convert said spoken information to spoken characteristic data.

17. The image storage system of claim 12 further comprising:
a plurality of text files, each with a corresponding file name;
a document processing engine configured to extract search keys from each of said files; and
said metadata further providing an association between said search keys and said file names.

18. The image storage system of claim 15 further comprising:
an object recognizer providing identification of objects within said captured images.

19. The images storage system of claim 15 further comprising a speech recognition engine configured to convert said spoken information to spoken characteristic data.

20. The image storage system of claim 15 further comprising a character recognition engine configured to provide the textual information.

21. A system for storing documents in an electronic storage media, said system comprising:
means for obtaining from each said document to be stored, data tags pertaining to certain characteristics of said document, said data tags selected from the list of character recognition, semantics processing, object recognition, and voice recognition; and
means for associating said data tags with each said document.

22. The system of claim 19 further comprising:
means for retrieving stored ones of said documents based upon receipt of a data tag associated with said document to be retrieved.
